(19) United States
(12) Patent Application Publication
(10) Pub. No.: US 2001/0033643 A1
(43) Pub. Date: Oct. 25, 2001

(54) Telephone privacy protection system

(76) Inventors: Kevin C.W. Mulvey, Alexandria, VA (US); Thomas E. Black, Folsom, CA (US)

Correspondence Address: VENABLE, Post Office Box 34385, Washington, DC, 20043-9998, US

(21) Appl. No.: 09/785,510

(22) Filed: Feb. 20, 2001

Related U.S. Application Data
(60) Provisional application No. 60/183,153, filed on Feb. 17, 2000.

(51) Int. Cl. H04M 3/00

(52) U.S. Cl. 379/196; 379/188

(57) ABSTRACT

A central station blocks calls for a subscriber. The central station receives a call from a caller and provides an audio message to the caller requesting that the caller provides a first indicator if the caller is an unwanted caller or a second indicator otherwise. The central station receives the first indicator or the second indicator. If the central station receives the first indicator, the call is blocked. If the central station receives the second indicator, the call is passed through.

### CROSS-REFERENCE TO RELATED APPLICATIONS

This application claims the priority of U.S. provisional patent application 60/183,153, filed Feb. 17, 2000, which is incorporated herein by reference.

### COPYRIGHT NOTICE

Portions of the disclosure of this patent document contain material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

1. Field of the Invention

The invention relates to a system for telephone privacy protection, particularly a system that blocks unwanted telephone calls, especially from telemarketers.

2. Background of the Invention

Receiving a call from a telemarketer is an unpleasant experience for most people. The call is often unwanted and often seems to come during an inopportune time, such as at dinner time. The telemarketer may be very pushy and use high pressure sales tactics, and the person called may find it difficult to hang up the telephone on the telemarketer. Further, the person called may feel obligated to listen to the telemarketer's sales pitch prior to hanging up the telephone so as not to be rude to the telemarketer, even though the telemarketer is being rude to the person called. In addition, to avoid talking to the telemarketer further, the person called may lie to the telemarketer to provide a way to end the call with the telemarketer. Moreover, if the person called hangs up the telephone while the telemarketer is still talking, the person called may feel angry, disgusted, or sad at having to be rude to a caller. There exists a need for a system to block calls from telemarketers that obviates the need for the person called to speak with telemarketers.

In addition, consumers are often victims of telemarketer fraud. According to the Federal Bureau of Investigation, consumers lose $40 billion per year to telemarketer fraud. The results from a National Consumers League survey states that 92% of adults have received fraudulent telemarketing calls.

Further, the telemarketing business is big business. For example, the three largest telemarketing companies in the United States have the ability to dial 100 people per second, 12 hours per day. Moreover, over 2 million people are employed by telemarketing companies. There exists a need to assist consumers in protecting their privacy from telemarketers.

To alleviate the pressure from the onslaught of telemarketers, some legislation has been passed to try to help consumers. For example, state legislation and federal regulations exist that establish so-called do-not-call lists. These laws require telemarketers to place the consumer on an internal “do-not-call” list if the consumer instructs them to do so in writing or verbally. In practice, these laws are often ineffective in reducing unwanted calls because the lists are maintained by telemarketing companies with no governmental oversight. Furthermore, many types of telemarketing calls are exempted from the regulations such as fund-raising calls, political surveys, and calls from companies the consumer has an existing or prior business relationship with, such as credit card companies. Moreover, it is often difficult to prove that a telemarketer has violated the law because computer-based dialing equipment is typically used and because telemarketers often block their caller ID information from being received by the called party. The number of consumers on do-not-call lists maintained by the telemarketing industry has grown from 500,000 in 1990 to over 3 million in 2000, which is around 20% growth in do-not-call lists per year. Despite these lists, the number of telemarketing calls and resulting consumer frustration continues to grow.

One problem with do-not-call lists is the inability for consumers to easily add their names to do-not-call lists. Consumers, for example, may not know that do-not-call lists exist or may not have the time to write a letter or instruct each telemarketer to put their names on the do-not-call lists. Another problem with do-not-call lists is that a consumers is burdened with the responsibility of notifying each telemarketer, of which hundreds exist and whose names and business addresses are difficult to obtain. In fact, the problem is so severe that a new industry has surfaced in the form of notification service companies, which charge consumers fees to maintain their names on nearly 1,500 do-not-call lists used by telemarketers.

There exists a need to help consumers take advantage of the pro-consumer legislation such that consumers can easily have their names placed on do-not-call lists.

### SUMMARY OF THE INVENTION

An object of the invention is to provide a system to assist consumers in protecting their privacy from telemarketers.

An object of the invention is to provide a system for telephone privacy protection from telemarketers, and other unwanted callers, that obviates the need for the person called to speak with such callers.

An object of the invention is to provide a system for telephone privacy protection from telemarketers that assists the person called to take advantage of legislation addressing calls from telemarketers.

An object of the invention is to provide a system to help consumers take advantage of the pro-consumer legislation such that consumers can have their names placed on do-not-call lists.

The invention includes a method, an apparatus, and a kit for blocking calls from unwanted callers, such as telemarketers.

The method of the invention includes a method for blocking calls for a subscriber comprising the steps of: receiving a call from a caller; providing a first audio message to the caller requesting the caller to provide a first indicator if the caller is an unwanted caller or a second indicator otherwise, wherein knowledge of the first indicator and/or the second indicator is not required by the caller; receiving the first indicator or the second indicator; blocking the call if the first indicator is received; and passing through the call if the second indicator is received.

The apparatus of the invention includes an apparatus for blocking calls for a subscriber comprising: means for receiving a call from a caller; means for providing a first audio message to the caller requesting the caller to provide a first indicator if the caller is an unwanted caller or a second indicator otherwise, wherein knowledge of the first indicator and/or the second indicator is not required by the caller; means for receiving the first indicator or the second indicator; means for blocking the call if the first indicator is received; and means for passing through the call if the second indicator is received.

The kit of the invention includes a kit comprising a central station to couple a telephone and a telephone line and to prevent the telephone from ringing if an unwanted caller calls the telephone.

The kit of the invention includes a kit comprising a digital ringer to couple a telephone and a telephone line, to suppress ringing of the telephone, and to produce a ringing sound when prompted by an activation code received via the telephone line.

The method of the invention includes a method for blocking calls for a subscriber comprising the steps of: receiving a call from a caller at a telephone number, the caller dialing the telephone number automatically; and providing an introduction message, wherein the introduction message is an electronic telephonic signal detectable by the caller such that the caller automatically disconnects the call and updates automatically a list to refrain from further calling the telephone number again.

The method of the invention includes A method for automatically dialing telephone numbers comprising the steps of: dialing a telephone number automatically to initiate a call; detecting an introduction message; disconnecting the call automatically; and updating automatically a list to refrain from further calling the telephone number again.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 illustrates a system view for a first embodiment of the invention.

FIG. 2 illustrates a flow chart for the first embodiment.

FIG. 3 illustrates a block diagram of an exemplary central station for the first embodiment.

FIG. 4 illustrates a front view of the central station of FIG. 3.

FIG. 5 illustrates a back view of the central station of FIG. 3.

FIG. 6 illustrates a block diagram of an exemplary digital ringer for the first embodiment.

FIG. 7 illustrates a front view of the digital ringer of FIG. 6.

FIG. 8 illustrates a back view of the digital ringer of FIG. 6.

FIG. 9 illustrates a system view for a second embodiment of the invention.

FIGS. 10A and 10B illustrates a flow chart of a second embodiment.

FIG. 11 illustrates a block diagram of an exemplary central station for the second embodiment.

FIG. 12 illustrates a flow chart for a third embodiment of the invention.

FIG. 13 illustrates a system view for a fourth embodiment of the invention.

FIG. 14 illustrates a block diagram of an exemplary central station for the fourth embodiment.

FIG. 15 illustrates a system view for a fifth embodiment of the invention.

FIG. 16 illustrates a flow chart for the fifth embodiment.

FIG. 17 illustrates a system view for a sixth embodiment of the invention.

FIG. 18 illustrates another system view for the sixth embodiment.

FIG. 19 illustrates a system view for a seventh embodiment of the invention.

FIG. 20 illustrates another system view for the seventh embodiment.

FIG. 21 illustrates a further system view for the seventh embodiment.

### DETAILED DESCRIPTION OF THE INVENTION

The invention blocks calls from unwanted callers, such as telemarketers. The invention answers all incoming calls and provides a recorded message with instructions for the caller. If the caller is an unwanted caller, the caller is instructed to respond appropriately, and upon receiving the appropriate response, the caller receives a polite hang-up. All other callers are transferred to connected telephones, or to an answering machine or an answering service. The invention is configured to minimize disruption to a family or business of a subscriber and is designed for ease of operation and low cost. If the caller is an unwanted caller, no telephones of the subscriber preferably ring, and the subscriber preferably does not interact with the unwanted caller.

As used herein, a “subscriber” refers to an entity (e.g., a person or an organization) that uses the invention. As an example, a subscriber may purchase or lease the invention embodied in an apparatus (e.g., purchasing or leasing a unit from a store, a business, or a contractor). As another example, a subscriber may purchase or lease the invention embodied in a method from another using the invention embodied in an apparatus (e.g., purchasing or leasing a service from a telephone company).

As used herein, an “unwanted caller” refers to any entity from whom a subscriber is not desirous of receiving a call. Examples of an unwanted caller include: a telemarketer; a bill collector; a business; and a former boyfriend or girlfriend. An unwanted caller is embodied in, for example: one or more persons; a company; and a system, such as a predictive dialing system, a computer to call automatically, or an automatic dialing apparatus.

As used herein, a “telemarketer” refers to any entity placing a call to another generally for purposes of solicitation. A telemarketer may solicit another to purchase or receive, for example: a product (e.g., vinyl siding, a coffee maker, or a magazine subscription); a service (e.g., a telephone long-distance service, or an investment service); a donation (e.g., a donation to a charity, a political party, or a foundation); a recruiter, commonly known as a “head hunter”; real estate (e.g., a vacation time share); an investment opportunity (e.g., a stock or bond investment); a vacation; an entry in a contest (e.g., an entry in contest for a vacation); a free product or service; a trial offer; and any combination of the above. Examples of a telemarketer include: one or more persons; a company; and a system, such as a predictive dialing system, a computer to call automatically, or an automatic dialing apparatus.

The description of the invention is segmented into six sections, one section for each of the embodiments of the invention.

First Embodiment

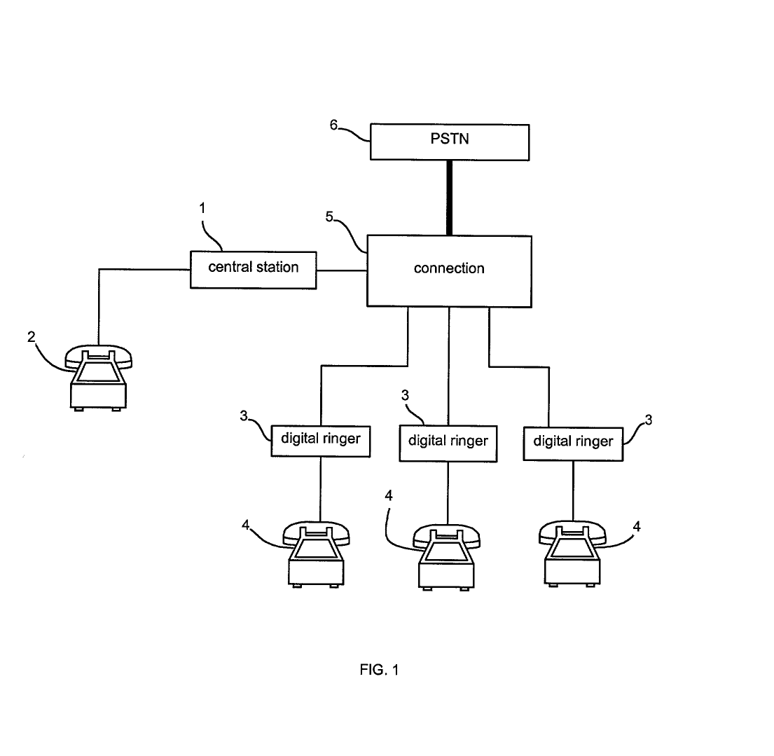

FIG. 1 illustrates a system view for a first embodiment of the invention. The first embodiment includes a central station 1 and, as an option, one or more digital ringers 3. The central station 1 couples a telephone 2 to a connection 5. Each digital ringer 3 couples a telephone 4 to the connection 5. Each telephone 2 and 4 may be, for example: a standard telephone, a cordless telephone, an answering machine, a personnel computer using a modem or having Internet access, a fax machine, or any combination of the above. The connection 5 is coupled to a public switch telephone network (PSTN). The connection 5 is, for example, a device (e.g., a junction box, a telephone company (teleco) punch block, a cable, or a wire) connecting all telephones inside a residence (e.g., a house, a townhouse, a condominium, or an apartment) or a business of a subscriber with a telephone line outside the residence or the business.

In general, the central station 1 and digital ringers 3 block calls from unwanted callers and pass through calls from non-unwanted callers. For each call, the telephones 2 and 4 do not initially ring. The central station 1 suppresses normal telephone line ring voltage to the telephone 2, which prevents the telephone 2 from ringing, and the digital ringers 3 suppress normal telephone line ring voltage to the telephones 4, which prevents the telephones 4 from ringing.

If a call is from an unwanted caller, the central station 1 and digital ringers 3 prevent the telephone 2 and telephones 4, respectively, from ringing, and the central station 1 disconnects the call. The invention advantageously does not allow the telephones 2 and 4 to ring if a unwanted caller calls and properly follows the instructions from the central station 1.

If a call is from a non-unwanted caller, the central station 1 and digital ringers 3 prevent the telephone 2 and telephones 4, respectively, from initially ringing. After the central station 1 determines the caller is a non-unwanted caller, the central station 1 rings the telephone 2. For example, the central station 1 rings a standard telephone, an answering machine, or a fax machine. Further, the central station 1 directs the digital ringers 3 to emit a ringer sound by sending an activation code to the digital ringers 3. Upon receiving the appropriate activation code, each digital ringer 3 emits a ringer sound.

The digital ringers 3 prevent the telephones 4 from ringing for any incoming call and provide a ringer sound for calls from non-unwanted callers. With the digital ringers 3 installed between the telephones 4 and the connection 5, the bell of each telephone 4 is disabled. If the call is from a non-unwanted caller, the central station 1 signals the digital ringers 3, and each digital ringer 3 simulates a ringer sound upon receiving the command from the central station 1.

If the call is from an unwanted caller, the digital ringers 3 and the telephones 4 do not ring. If the call is from a non-unwanted caller, the digital ringers 3 ring pursuant to an activation command from the central station 1, and the telephones 4 do not ring.

In general, a digital ringer 3 is connected between a telephone 4 and the connection 5 at any location where the subscriber desires to suppress the telephone 4 from ringing until the central station 1 has cleared the call and to hear a ringing when the central station 1 has cleared and passed through the call. As an option, a digital ringer 3 can be coupled to connection 5 without being coupled to a telephone 4.

As an option, instead of emitting a ringing sound on command from the central station 1, the digital ringers 3 can provide a signal to the telephones 4 to ring, similar to the signal provided by the central station 1 to the telephone 2.

In FIG. 1, one central station 1 and three digital ringers 3 are shown. Preferably, one central station 1 is connected to a primary telephone 2, and one digital ringer 3 is connected to each secondary telephone 4. In general, one central station 1 and one or more digital ringers 3 are used, depending on the number of secondary telephones 4. Preferably, up to six digital ringers 3 are used with one central station 1. Conventionally, six standard bell loads are assumed for an average telephone line. If there are no secondary telephones 4, no digital ringers 3 are needed.

As an option, not every telephone 4 has a digital ringer 3. With this option, each telephone 4 without a digital ringer 3 operates as is conventional.

As an option, no digital ringers 3 are used. With this option, the telephones 4 operate as is conventional.

As an option, multiple telephones can be coupled to the central station 1.

As an option, multiple telephones can be coupled to each digital ringer 3.

The connection 5 in FIG. 1 is depicted as a hub. Other types of connections are possible. For example, the connection 5 can be one or more hubs, one or more linear connections, and any combination thereof.

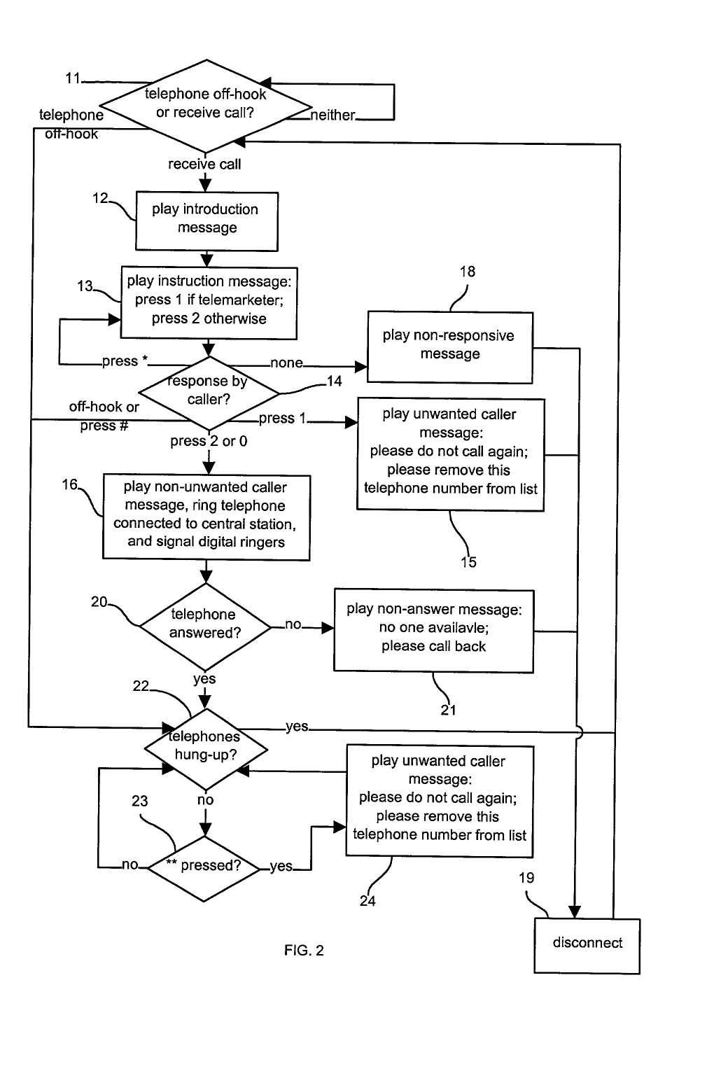

FIG. 2 illustrates a flow chart for the first embodiment of the invention. In block 11, the central station 1 is in an idle state awaits to receive a call or for a telephone 2 or 4 to go off-hook. If a call is received, the call is routed to the central station 1 and the digital ringers 3 via the PSTN 6 and the connection 5. The central station 1 receives the call and prevents the telephone 2 from ringing. Each digital ringer 3 also receives the call and prevents the corresponding telephone 4 from ringing. If a call is received, flow proceeds to block 12. If one of the telephones 2 or 4 goes off-hook, flow proceeds to block 22. Otherwise, flow loops back to block 11.

In block 12, the central station 1 plays an introduction message for the caller. The introduction message acts as an identifier to the caller that a call blocking system is in place. The introduction message can cause predictive dialing systems to disconnect. Further, predictive dialing systems can be modified to update their internal systems to remove the called telephone number from a to-call list upon detecting the introduction message. Further, the introduction message provides repeat callers (e.g., family and friends) with a pleasant audible interface.

The introduction message is, for example: a digitally recorded voice message; a tone; a note series, which may be musical; or any combination of the above. As a digitally recorded voice message, the introduction message can be, for example, the name of the product or service embodying the invention. As a tone, the introduction message can be, for example, a note or a trademarked tone. Preferably, the tone is not a standard service interruption tone (SIT). As a note series, the introduction message can be identified with a particular product, service, or source of products or services and can be, for example, a trademarked note series. The tone or note series is preferably within the listening range of humans.

With the introduction message, predictive dialing systems that use cadence detection algorithms or are programmed to listen for a particular message, tone, or note series detect the introduction message and automatically disconnect. The introduction message advantageously makes it easier for computer-operated dialing systems, which are conventionally used for telemarketing, to disconnect automatically when encountering a subscriber who does not want to receive calls from telemarketers. Moreover, upon detection of a particular message, tone, or note series, predictive dialing systems can be programmed to add the name of the called party (e.g., the name of the subscriber, or the name corresponding to the telephone number called by the predictive dialing system) and/or the telephone number dialed to a do-not-call list or to remove the name of the called party and/or the telephone number dialed from a to-call list. More generally, upon detection of a particular electronic telephonic signal, predictive dialing systems can be programmed to add the name of the called party and/or the telephone number dialed to a do-not-call list or to remove the name of the called party and/or the telephone number dialed from a to-call list.

In block 13, the central station 1 plays an instruction message for the caller. The instruction message instructs the caller to press one touch tone key on the telephone of the caller if the caller is an unwanted caller and another touch tone key on the telephone of the caller if the caller is a non-unwanted caller. The instruction message may be for example: “Hello and thank you for calling. If you are a telemarketer, please disconnect or press 1 now. If you are not a telemarketer, please press 2 now and someone will be with you shortly.” Preferably, the instruction message is factory recorded and cannot be changed by the subscriber. As an option, the instruction message may be recorded and/or changed by the subscriber.

In block 14, the response by the caller is ascertained by the central station 1. By responding, the caller provides the central station 1 with a dual tone multi-frequency (DTMF) signal by pressing a numbered key on the telephone of the caller. If the caller presses a key identifying the caller as an unwanted caller (e.g., presses 1 in the example of block 13), flow proceeds to block 15. If the caller presses a key identifying the caller as a non-unwanted caller (e.g., presses 2 in the example of block 13), flow proceeds to block 16. If telephones 2 or 4 go off-hook or if the # key is pressed, flow proceeds to block 22. If the caller presses the * key, flow proceeds back to block 13. If the caller presses the 0 key, flow proceeds to block 16, which is a desirable routing because many callers are predisposed to pressing the 0 key when encountering a recorded audio message. If the caller presses no key within a time period, flow proceeds to block 18.

In block 14, if either one of the telephones 2 or 4 is off-hook or the # key is pressed, the central station 1 goes to an idle state. If one of the telephones 2 or 4 goes off-hook while the central station 1 is processing the call, the central station 1 detects the off-hook condition and goes to the idle state. For the telephone 2, the central station 1 detects off-hook status by monitoring loop current. For the telephones 4, the central station 1 detects off-hook status by monitoring for a voltage drop in the telephone line that occurs when one of the telephones 4 goes off-hook. If the off-hook condition is not detected, the # key is pressed by the subscriber to place the central station 1 in the idle state.

As an option, the central station 1 can additionally or alternately receive and process a voice response from the caller. With this option, the introduction message in block 13 may be for example: “Hello and thank you for calling. If you are a telemarketer, please disconnect or press or say 1 now. If you are not a telemarketer, please press or say 2 now and someone will be with you shortly.”

In block 15, the caller pressed a key and is identified as an unwanted caller. The central station 1 plays an unwanted caller message for the caller. The unwanted caller message is, for example: “We are sorry, but this telephone number does not except calls from telemarketers. You are instructed to stop calling. You must immediately remove this number from your telephone list. Thank you.” From block 15, flow proceeds to block 19, in which the call is disconnected.

In block 16, the caller pressed a key and is identified as a non-unwanted caller. The central station 1 plays a non-unwanted caller message, rings telephone 2 connected to the central station 1, and signals the digital ringers 3. The non-unwanted caller message is, for example: “Thank you! Your call is being transferred now.” As an option, the non-unwanted caller message is not played. The central station 1 rings telephone 2 and provides a ring-back tone to the caller. In addition, the central station 1 signals the digital ringers 3 to ring. The central station 1 signals the digital ringers 3 via a signal sent, for example, via the telephone lines or via a wireless communication link. From block 16, flow proceeds to block 20.

In block 18, the caller failed to press any key within the time period, and the central station 1, plays a non-responsive message. The non-responsive message is, for example: “We are sorry, but you did not make a selection. Good-bye.” The time period is sufficiently long (e.g., preferably greater than 8 seconds) so that typical telemarketing predictive dialing software can detect the instruction message in block 13 as a recorded message and disconnect. This aspect of the invention also minimizes the number of calls from predictive dialing systems, which reduces the number of unsolicited calls. From block 18, flow proceeds to block 19.

As an option, the caller can be given the opportunity to play the instruction message in block 13 again. With an appropriate response by the caller, flow loops back to block 13 from block 18. The non-responsive message is, for example: “We are sorry, but you did not make a selection. Good-bye. Press the * key to try again or simply hang-up.” With this example, if the caller presses the * key, flow proceeds to block 13, and if the * key is not selected within a second time period (e.g., 8 seconds), flow proceeds to block 19.

In block 19, the call is disconnected. The central station 1 is reset to receive another call or detect a telephone off-hook in block 11.

In block 20, the central station 1 determines if the telephone 2 or any telephone 4 is answered. The central station 1 continues to send out ring signals to the digital ringer 3 in normal ring intervals until such time that the central station 1 perceives that the call has been answered or not. The central station 1 determines the call is not answered after, for example, a specified number of rings (e.g., 5 rings) or a time period expires (e.g., 30 seconds). If no telephone 2 or 4 is answered, flow proceeds to block 21. If any telephone 2 or 4 is answered, flow proceeds to block 22. If the caller hangs-up flow proceeds to block 19 (not shown).

In block 21, a non-answer message is played by the central station 1. The non-answer message is, for example: “We are unable personally to answer your call at this time. Please hang up and call us back later.” From block 21, flow proceeds to block 19.

In proceeding to block 22, one of the telephones 2 or 4 is off-hook to place a call or to answer a call, for example, by a person, an answering machine, or an answering service. While waiting for the subscriber and the caller to hang-up, the central station 1 cycles between blocks 22 and 23.

In block 22, the central station 1 determines if the telephones of the subscriber and the caller are hung-up. If the telephones are hung-up, flow proceeds to block 11. If the telephones are not hung-up, flow proceeds to block 23.

In block 23, the central station 1 determines if the * key is pressed twice consecutively, which is referred to herein as “**.” This feature enables the subscriber to disconnect a caller or a called party. If ** is pressed, the central station disconnects the call, and flow proceeds to block 24. If ** is not pressed, flow proceeds to block 22.

In block 24, the central station 1 plays an unwanted caller message. Block 24 is the same as block 15. From block 24, flow proceeds to block 22.

As an option for block 13, the requirement that a non-unwanted caller press a key is excluded. With this option, a caller who is a non-unwanted caller is not required to press a touch tone key to have the call passed through the system.

As another option for block 13, additional touch tone options are included with the instruction message in block 13. For example, a number of additional options can be presented to the caller This feature may be desirable to route various callers to various recipients. The subscriber programs the central station 1 and records the instruction message. An exemplary instruction message recorded by the subscriber is: “Hello and thank you for calling. If you are a telemarketer, please disconnect or press 1 now. If you are calling for Mr. Mulvey, please press 2 now. If you are calling Mr. Black please press 3 now.” Depending if 2 or 3 was pressed by the caller, the central station 1 causes the telephone 2 and the digital ringer 3 to ring in different patterns based on the touch tone number entered by the caller.

As another option, the central station 1 is modified to produce a special ring pattern provided by the telephone company. Such ring patterns are available as distinctive ringing services from telephone companies, such as the so-called Identa-Ring service. With this option, if the call is determined to be authorized, the central station 1 remembers the original ring pattern from the telephone company and duplicates the ring pattern to ring the telephone 2 and digital ringers 3.

As a further option, the central station 1 and the digital ringers 3 are modified to accept calls from multiple telephone lines. Each telephone line functions separately from the other telephone lines. Depending on which telephone line a call originated, the central station 1 provides a different ring pattern for the telephone 2 and digital ringers 3.

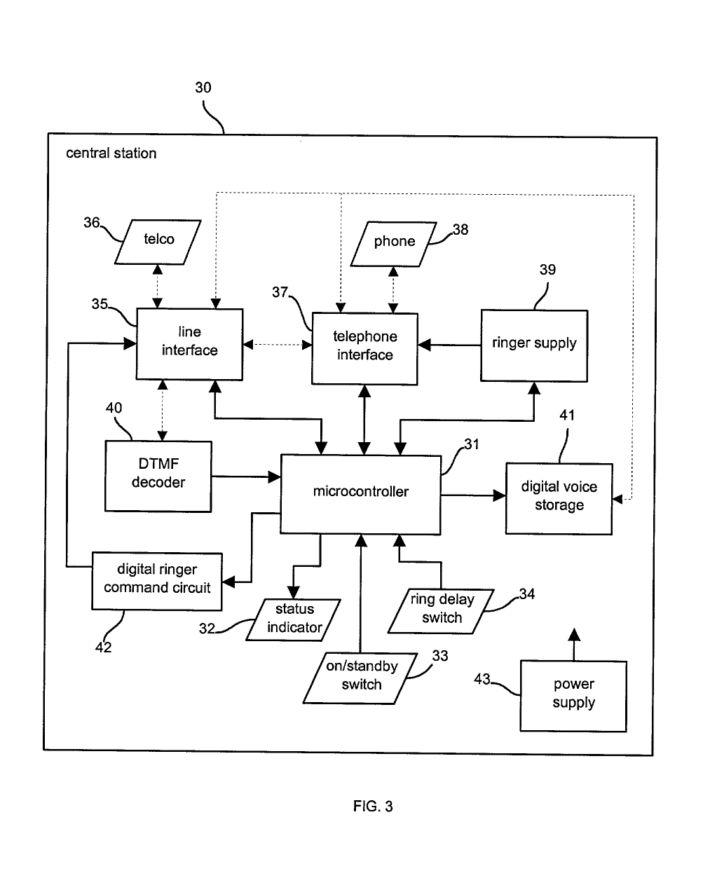

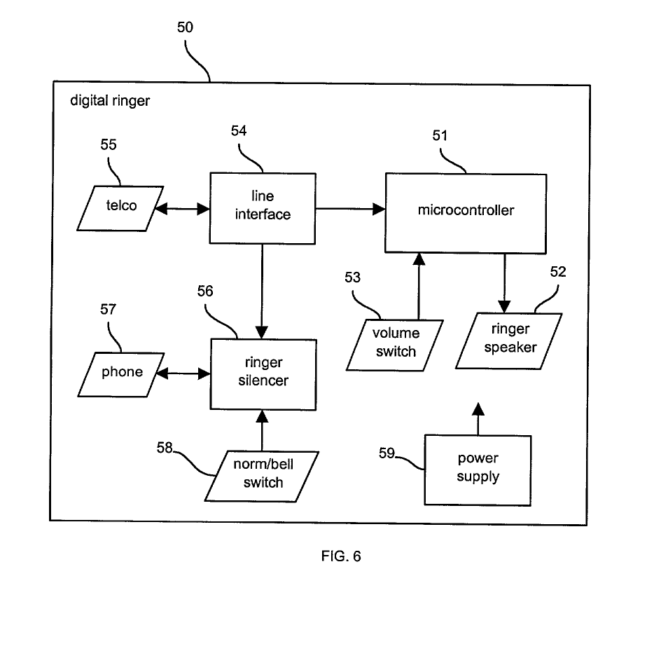

The central station 1 and digital ringers 3 can be implemented in a variety of ways. In one preferred embodiment, the central station 1 is implemented as illustrated with FIGS. 3-5, and the digital ringers 3 are implemented as illustrated with FIGS. 6-8.

FIG. 3 illustrates a block diagram of an exemplary central station 30. The central station 30 is a preferred example of the central station 1 in FIG. 1. The central station 30 includes a microcontroller 31, a line interface 35, a telephone interface 37, a ringer supply 39, a DTMF decoder 40, a digital voice storage 41, a digital ringer command 42, and a power supply 43. In the block diagram, all digital control lines (e.g., input/output (I/O)) are shown as solid lines, and the audio paths are shown as dotted lines.

The microcontroller 31 is the main design element in the central station 30 and is preferably an integrated circuit. A microcontroller is a specialized microprocessor that is a software driven device. A microcontroller can generally replace dozens (and sometimes hundreds) of discrete components, which reduces cost and improves reliability. Because a microcontroller is controlled by software, a microcontroller offers very flexible operation and can reduce complex tasks to simplified steps. To realize a central station 30 that is compact and easy-to-use, the microcontroller 31 is preferred.

The microcontroller 31 is responsible for controlling most of the functions in the central station 30. The microcontroller 31 is, for example, a PICmicro device, which is manufactured by Microchip Technology of Chandler, Ariz. Software (called “firmware”) permanently resides in the microcontroller 31 and is custom designed for the application. In a preferred embodiment, the software for the microcontroller 31 requires 2 to 4 kilobytes (KB) of read only memory (ROM), which is integrated into the microcontroller 31 and is not a separate component, which ensures high reliability. As an option, the ROM is provided in a separate component coupled to the microcontroller 31. The software in the microcontroller 31 is preferably copyright protected and difficult to decode or decipher via a privacy protection feature, which is standard on PICmicro devices. In addition, the software is preferably Y2K compliant and operates correctly beyond the year 2000.

A status indicator 32 is coupled to the microcontroller 31 and displays the status of the central station 30. Preferably, the status indicator 32 is a light-emitting diode (LED) and has four states: steady on, slow blink, fast blink, and off. In the steady on state, the status indicator indicates that the central station 30 is on and is ready to answer a call. In the slow blink state, the status indicator 32 indicates that a call is being processed by the central station 30. In the fast blink state, the status indicator 32 indicates that the central station 30 is sending a ring signal to the telephone 2 and the digital ringers 3 or indicates that the central station 30 is in a system programming mode. In the off state, the status indicator 32 indicates that the central station 30 is in a standby mode or off mode.

An on/standby switch 33 is coupled to the microcontroller 31 and places the central station 30 in an on mode or a standby or off mode. The switch 33 permits the subscriber of the central station 30 to disable the central station 30. In the on mode, the central station 30 answers all incoming calls. In the standby mode, the central station 30 answers no incoming calls and permits the telephone 2 to operate normally. The ** feature of block 23 is preferably available during the standby mode. The digital ringers 3 operate independently of the mode of the central station 30.

A ring delay switch 34 is coupled to the microcontroller 31 and sets the number of times a ring signal is received by the central station 30 prior to the central station 30 answering a call. Preferably, the ring delay switch has three settings to answer in one ring (silent bell for telephone 2), one ring (bell rings for telephone 2), or four rings (bell rings for telephone 2).

The line interface 35 couples the central station 30 via a port 36 to the connection 5. The line interface 35 controls information to and from the port 36. The line interface 35 includes a ring detector, a telephone company (telco) line transformer, a line voltage monitor for extension detection, and a loop current detector for calling party control (CPC) and off-hook detection.

The port 36 is preferably a standard RJ-11 modular female jack. Preferably, a telephone line from connection 5 is coupled to port 36. The telephone line coupled to port 36 is shared with a caller identification (Caller ID) device to display the telephone number of the caller.

The telephone interface 37 couples the central station 30 via a port 38 to the telephone 2. The telephone interface 37 controls information to and from the port 38. Communication with the port 38 is switched between a main phone line (e.g., for normal use), an internal talk voltage source (e.g., for system programming), and a 90 VAC (voltage alternating current) ring generator (e.g., for activating a bell in the telephone 2). The telephone interface 37 includes a loop current detector to sense on-hook and off-hook conditions of the telephone 2. The port 38 is preferably a standard RJ-11 modular female jack.

The ringer supply 39 is a high voltage ring generator that provides AC bell power via the port 38 to ring the telephone 2. The ringer supply 39 produces a 90 VAC at 20 Hz, which is superimposed on a 12 VDC (volts direct current) talk voltage. The ringer supply 39 can preferably drive at least two bell loads.

The DTMF decoder 40 is used to sense DTMF touch tone signals from the caller or the subscriber during a call or from the subscriber during system programming. The DTMF decoder 40 converts the DTMF touch tone signals to 4 bit codes that are provided to the microcontroller 31. The DTMF decoder 40 is, for example, an industry standard M-8870 DTMF decoder integrated circuit, which is available from, for example, Teltone Corporation of Bothell, Washington or Mitel Corporation of San Diego, Calif. The M-8870 chip is preferred due to is very low cost and great availability. As an option, to eliminate the DTMF decoder 40, software running on the microcontroller 31 performs the DTMF decoding.

The digital voice storage 41 stores several seconds of pre-recorded speech. For example, the digital voice storage 41 is one of the extension line of single chip digital recorder integrated circuits marketed under the name ChipCorder® and manufactured by Information Storage Devices, Inc. of San Jose, Calif. The ChipCorder® product line is desirable due to its extensive audio quality and bandwidth, which is highly suitable for telecommunications applications. The digital voice storage 41 includes a voice storage time of sufficient duration to store the messages discussed above with respect to FIG. 2. Preferably, the voice storage time of the digital voice storage 41 is approximately 40-60 seconds.

The digital ringer command circuit 42 transmits a ring activation code to the digital ringers 3. Based on communications from the microcontroller 31, the digital ringer command circuit 42 provides the activation code at the start of each ring period to the digital ringers 3 via the line interface 35, port 36, and the telephone line of the subscriber. Each digital ringer 3 connected to the telephone line is activated via the activation code. The activation code is preferably an audible tone that sounds like a common ring back call progress tone. Alternatively, the activation code is implemented in other ways, for example, by sub-audible tones, superimposed signaling, carrier current, low power radio frequency, spread spectrum signaling, or infrared signaling.

The power supply 43 provides power to the components of the central station 30 and is preferably a low voltage DC power supply. More preferably, the power supply 43 has a typical linear design that provides regulated 5 VDC and 12 VDC. For example, a small 12 VAC/500 mA wall-mounted transformer (e.g., 115 VAC/60 Hz) provides sufficient power and is connected to the central station via a 5.5 mm coaxial female jack. The transformer is preferably listed by the Underwriter's Laboratory (UL).

As an option, the central station 30 is able to accept user programmable options, which are input by the subscriber via the telephone 2 connected to the central station 30. The options are transmitted to the central station 30 via DTMF touch tone signals from the telephone 2. The settings are saved in a non-volatile electronically erasable programmable read-only memory (EEPROM) memory and are not lost among power interruption. Currently memory retention for such a memory is greater than 10 years.

During an AC power failure, the telephone 2 continues to work normally. This feature of the central station 30 ensures that emergency calls can be made and/or received during power outages.

The central station 30 is FCC Part 68 type accepted and approved for direct connection to the PSTN 6. The central station 30 has an FCC ringer equivalency load rating of 0.4 B.

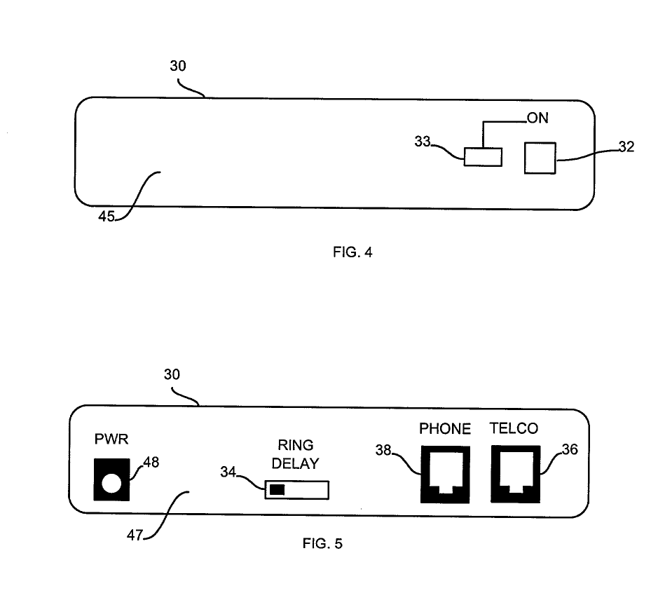

FIG. 4 illustrates a front view of the central station 30. From the front view, a front panel 45 of the central station 30 is visible. The front panel 45 includes the status indicator 32 and the on/standby switch 33.

FIG. 5 illustrates a back view of the central station 30. From the back view, a rear panel 47 of the central station 30 is visible. The rear panel 47 includes the ring delay switch 34, the port 36, the port 38, and a port 48. The port 48 is coupled to the power supply 43.

Preferably, the port 48 is capable of receiving a connector from a standard 5.5 space mm coaxial type cable from a wall-mounted transformer, as discussed above, for the power supply 43. For ease of identification, the port 36 is labeled “TELCO,” and the port 38 is labeled “PHONE.”

FIG. 6 illustrates a block diagram of an exemplary digital ringer 50. The digital ringer 50 is a preferred embodiment of the digital ringers 3 in FIG. 1. The digital ringer 50 includes a microcontroller 51, a line interface 54, a ringer silencer 56, and a power supply 59.

The microcontroller 51 is responsible for decoding a code signal from the central station 30 to activate a ring signal, generating the ring signal, and detecting a low battery condition. The microcontroller 51 is, for example, a PICmicro integrated circuit manufactured by Microchip Technology of Chandler, Arizona. The software for controlling the digital ringer permanently resides in the microcontroller 51 and is custom designed for the application. In a preferred embodiment, the software for the microcontroller 51 requires less than 512 bytes of ROM, which is integrated into the microcontroller 51 and is not a separate component, which ensures high reliability. As an option, the ROM is provided in a separate component coupled to the microcontroller 51. The software in the microcontroller 51 is preferably copyright protected and difficult to decode or decipher via a privacy protection feature, which is standard on PICmicro devices. In addition, the software is preferably Y2K compliant and operates correctly beyond the year 2000.

A ringer speaker 52 is coupled to the microcontroller 51 and produces the ringer sound. Preferably, the ringer sound is a pleasant sound, such as a warble, which is used in conventional electronic telephones.

A volume switch 53 is coupled to the microcontroller 51 and selects the sound level for the ringer sound emitted from the ringer speaker 52. The volume switch 53 is controlled by the subscriber.

The line interface 54 couples the digital ringer 50 via a port 55 to the connection 5. The line interface 54 includes a signal conditioning circuit to detect the ring activation code sent by the central station 30. If a ring activation code is detected, the line interface 54 forwards the ring activation code to the microcontroller 51. The ring activation code is analyzed by the microcontroller 51 for authenticity, and if the ring activation code is accepted, the microcontroller 51 generates the warble for the ringer speaker 52.

The port 55 is preferably a standard RJ-11 modular female jack. Preferably, a telephone line from connection 5 is connected to port 55. The telephone line coupled to port 55 is shared with a Caller ID device to display the telephone number of the caller.

The ringer silencer 56 couples the digital ringer 50 via a port 57 to a telephone 4. The ringer silencer 56 prevents the telephone 4 from ringing. The ringer silencer 56 removes the AC ring voltage from the telephone line connected to port 55 and does not permit AC ring voltage from being transmitted via port 57 to the telephone 4. Although the ringer silencer 56 renders the bell of the telephone 4 inactive, the ringer silencer 56 does not interfere with normal operation of the telephone 4. The port 57 is preferably a standard RJ-11 modular female jack.

A norm/bell switch 58 is coupled to the ringer silencer 56 and directs the ringer silencer 56 to prevent or pass the AC ring voltage from passing to the port 57. In the norm mode, the ringer silencer prevents the AC ring voltage from passing to the port 57, and in the bell mode, the ringer silencer passes the AC ring voltage from passing to the port 57.

The power supply 59 provides power to the components of the digital ringer 50. Preferably, the power supply is 4 AA side disposable batteries, which have a service life of approximately one year. When battery power becomes low, the digital ringer 50 emits a low battery beep every few minutes. Using software, the microcontroller 51 monitors the battery voltage via a zener diode input for levels below, for example, 4.5 VDC.

The bell disabling feature of the digital ringer 50 may prevent some Caller ID devices from operating due to the removal of the AC ring voltage in the telephone line to the telephone 4. For a separate Caller ID device, as discussed above, the telephone line coupled to the digital ringer 50 is shared with a Caller ID device. This coupling is accomplished, for example, by using a modular T adapter. The input side of the modular T adapter is coupled to the connection 5, and the output side of the modular T adapter is coupled to the Caller ID device and the digital ringer 50. If the Caller ID capability is included with the telephone 4, the norm/bell switch 58 on the digital ringer 50 can be set to the bell position to pass the AC ring voltage to the telephone 4 via the port 57. With the switch 58 in the bell position, however, the bell of the telephone 4 will not be silenced by the digital ringer 50.

The digital ringer is FCC Part 68 type accepted and has an FCC ringer equivalency load rating of 0.2 B.

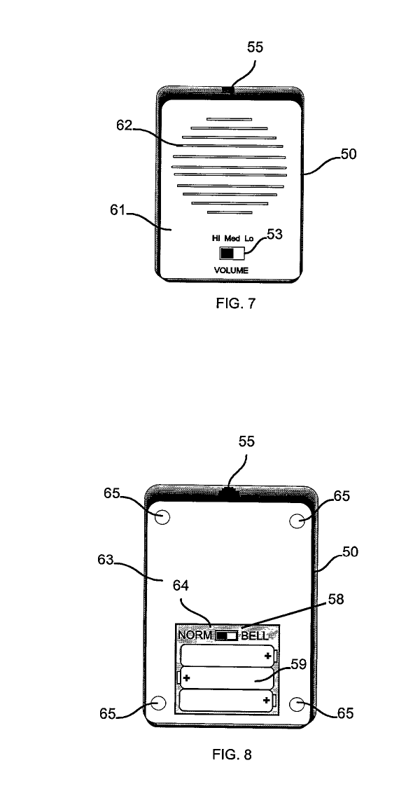

FIG. 7 illustrates a front view of the digital ringer 50. From the front view, a front panel 61 of the digital ringer 50 is visible. The front panel 61 includes slots 62 to emit audible sounds from the ringer speaker 52. The front panel 61 includes access to volume switch 53. The top of the digital ringer 50 includes access to port 55 to couple the digital ringer 50 to the connection 5. The bottom of digital ringer 50 includes access to port 57 (not shown in FIG. 7) to couple the digital ringer 50 to the telephone 3.

FIG. 8 illustrates a back view of the digital ringer 50. From the back view, a rear panel 61 of the digital ringer 50 is visible. The rear panel 63 includes an access area 64, which has a removable cover (removed and not shown in FIG. 8). The access area 64 provides access to the norm/bell switch 58 and the power supply 59. The power supply 59 is three AA batteries.

As an option, instead of emitting a ringing sound on command from the central station 30, the digital ringer 50 can provide a signal to the telephones 4 to ring, similar to the signal provided by the central station 30 to the telephone 50. With this option, the digital ringer 50 includes a ringer supply 39 activated by the microcontroller 51 and coupled to the port 57 via a telephone interface 37. Further, the power supply 59 is preferably more powerful, like the power supply 43.

Both the central station 30 and the digital ringer 50 are packaged in stylish compact high-impact plastic enclosures. Each enclosure is custom designed, and four external case screws (e.g., screws 65 in FIG. 8) hold the plastic enclosures together and provide for minimal assembly labor. With realizable small designs, the central station 30 and the digital ringers 50 can be installed at any convenient location, such as on a desk or on a wall.

Both the central station 30 and the digital ringer 50 have components mounted on a printed circuit board which is, for example, a FR4/G10 fiberglass or a low cost phenolic material. The circuit components are preferably surface mounted except for those that offer a lower cost through-hole package. To reduce assembly time and labor costs, all components are directly installed on the circuit board, including the switches and RJ-11 jacks. Each circuit board is held in place by two interlocking ears, which are molded in the enclosure, and four screws. Preferably, the design does not require factory adjustments or field adjustments.

In a preferred embodiment, a kit is provided and includes one central station 30. In another embodiment, the kit additionally includes one digital ringer 50. In a further embodiment, the kit additionally includes: a wall transformer of 12 VAC/500 mA; a 7 foot modular cord; a 3 foot modular cord; an instruction book; and a warranty card. As an option, batteries can be included with the kit, but are preferably not included to reduce costs. As an option, the kit includes two or more digital ringers 50. As an option, the kit includes no digital ringers 50, and a separate kit includes one or more digital ringers 50.

Each function block in FIGS. 3 and 6 for central station 30 and digital ringer 50, respectively, can be implemented with a number (e.g., dozens) of electronic components. As those skilled in the art will recognize, other circuitry and software than that described herein can be designed to implement the invention. For instance, much of the circuitry on the printed circuit board of the central station 30 can be reduced to a single chip, and much of the circuitry on the printed circuit board of the digital ringer 50 can be reduced to a single chip. Further, software to implement the invention can be written in the C computer language, as well as many other languages, depending on the microcontroller used. Moreover, one or more microcontrollers, microprocessors, and the like can be used to implement the invention.

Second Embodiment

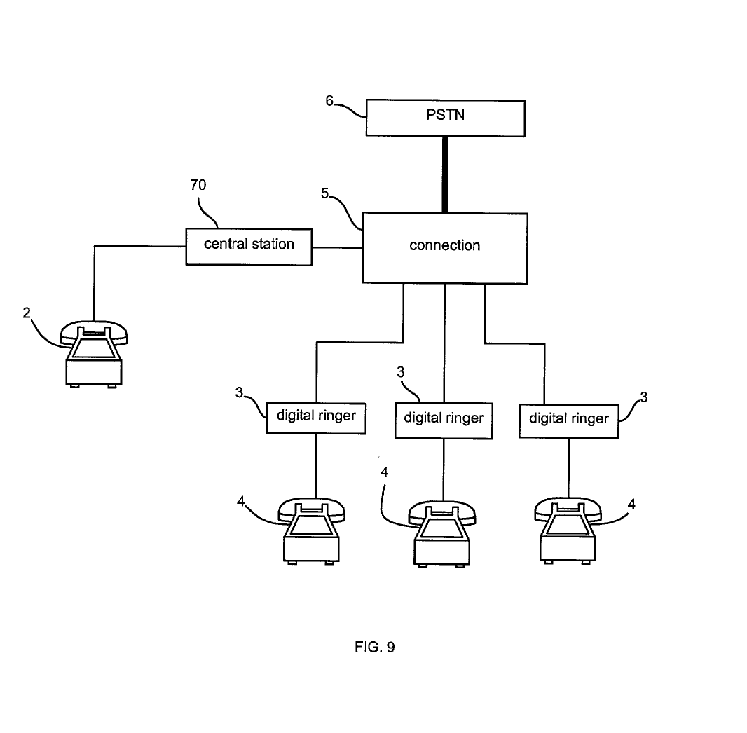

The second embodiment is an augmented version of the first embodiment of the invention. FIG. 9 illustrates a system view for the second embodiment of the invention. The second embodiment employs the same system view as illustrated in FIG. 1 for the first embodiment but uses a modified version of the central station, shown as central station 70.

In the second embodiment, the central station 70 obtains an identification signal, for example the telephone number or the name, of the caller. The identification signal is preferably obtained using conventional Caller ID techniques. Based on the identification signal, the central station 70 screens the call by comparing the identification signal to stored identification signals. Stored identification signals are identified as authorized or unauthorized and are stored in an authorized list and an unauthorized list, respectively. If a call is determined to have an identification signal matching an authorized identification signal, the call is passed through by this screening. If a call is determined to have an identification signal matching an unauthorized identification signal, the call is blocked by this screening. If a call is determined to have an identification signal matching no previously stored identification signals, the call is processed as in the first embodiment.

The subscriber selects the identification signals to store in the authorized list and the unauthorized list. Identification signals can be added or deleted in a system programming mode and can be added during a call. The subscriber selects the identification signals for storage using a keypad of the central station 70 or the keys of the telephone 2 and views stored identification signals via a display of the central station 70. During a system programming mode, the identification signals to be stored are preferably entered using DTMF touch tone signals from the telephone 2.

The authorized list and the unauthorized list have pre-set limits on the number of identification signals that can be added to each list. Once all of the entries are occupied by identification signals, each list acts as a first-in-first-out (FIFO) register and replaces the oldest saved identification signal with the newest identification signal. Preferably, 100 entries are available for both lists. More preferably, the authorized list has 50 pre-set entries, and the unauthorized list has 50 pre-set entries. Additional entries can be added or deleted based on hardware and cost considerations.

Preferably, the authorized list and unauthorized list are able to store identification signals for an unidentifiable caller, for example a caller having an out-of-area Caller ID, an unavailable Caller ID, a call blocked Caller ID, and an unknown Caller ID. As an option, identification signals for an unidentifiable caller are permanently stored by the central station 70, and during a system programming mode, the subscriber programs these permanent identification signals as being authorized, unauthorized, or undetermined.

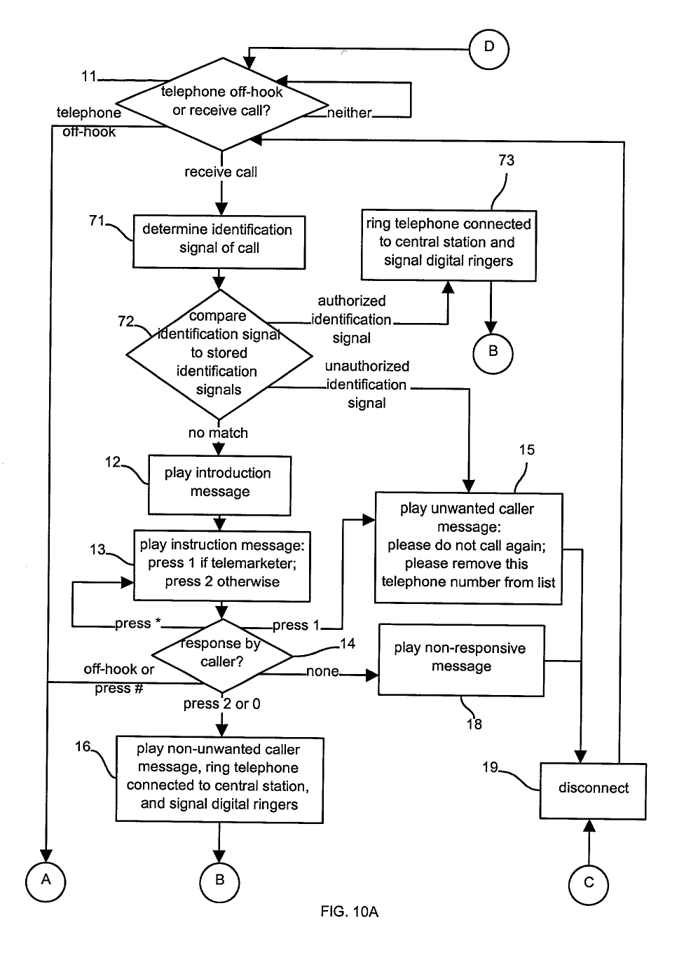

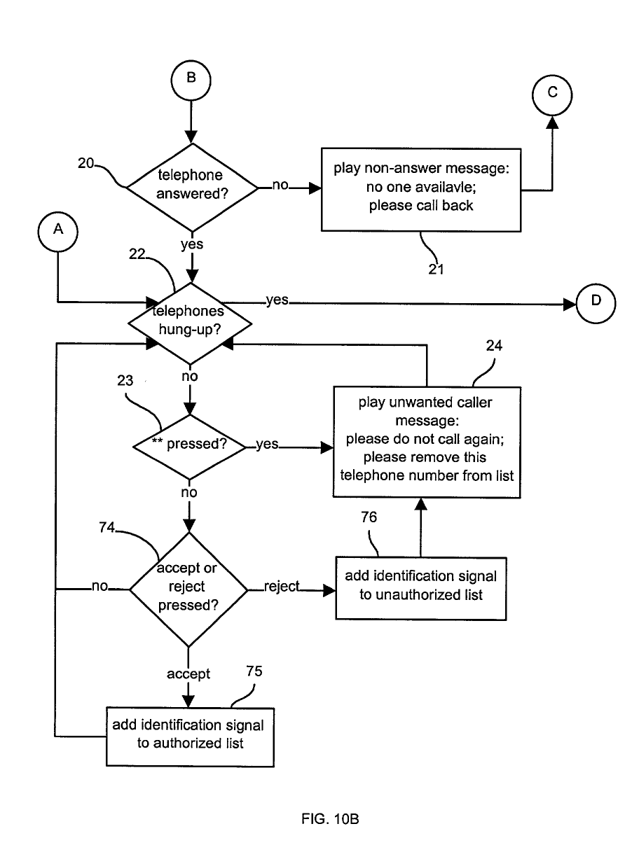

FIGS. 10A and 10B illustrate a system view of the second embodiment. FIGS. 10A and 10B are similar to FIG. 2 with the addition of block 71-76 and is discussed only with respect to the additional blocks. The connectors A, B, C, and D in FIG. 10A connect to connectors A, B, C, and D in FIG. 10B.

Blocks 71-73 screen the call using an identification signal of the call. In block 71, the central station 70 determines the identification signal of the call and displays the identification signal on the display of the central station 70. Using Caller ID, as in conventional systems, the identification signal, such as telephone number or the name of the caller, is determined. The identification signal preferably includes an identification signal from an unidentifiable caller.

In block 72, the central station 70 compares the identification signal with stored identification signals. Preferably, the central station 70 completes blocks 71 and 72 within one ring of the call. If the identification signal matches an identification signal stored in the authorized list, flow proceeds to block 73. If the identification signal matches an identification signal stored in the unauthorized list, flow proceeds to block 15. If the identification signal does not match an identification signal stored in either the unauthorized list or the authorized list, flow proceeds to block 12.

In block 73, the central station 70 rings the telephone 2 and signals the digital ringers 3 to produce ringer sounds. Block 73 is similar to block 16, except the non-unwanted caller message is not played. Block 73, flow proceeds to block 20.

As an option for FIG. 10A, block 12 is placed between blocks 11 and 71 or between blocks 71 and 72. With this option, the introduction message is played for all callers.

As another option for FIG. 10A, instead of flow proceeding from block 73 to block 20, an additional loop is substituted. The output of block 73 flows to block 20. If the telephone is not answered in block 20, flow proceeds to blocks 21 and 19 as described in the first embodiment. If the telephone is answered in block 20, flow proceeds to the loop of blocks 22 and 23 as described in the first embodiment. As an option, block 22 is eliminated from this loop.

Blocks 74-76 perform the addition of the identification signal of the call to either the authorized list or the unauthorized list.

In block 74, the central station 70 determines if the accept key or its equivalent is pressed, if the reject key or its equivalent is pressed, or if no such key is pressed. During a call, identification signals are added to the authorized list and the unauthorized list by the subscriber pressing an accept key or a reject key, respectively, of the keypad of the central station 70. Further, an accept key equivalent and a reject key equivalent can be entered by the user from the telephones 2 or 4. For example, the accept key equivalent is the * key and the 1 key (i.e., *1), and the reject key equivalent is the * key and the 2 key (i.e., *2). If the accept key or its equivalent is pressed, flow proceeds to block 75. If the reject key or its equivalent is pressed, flow proceeds to block 76. If neither the accept key or its equivalent nor the reject key or its equivalent is pressed, flow proceeds to block 22.

In block 75, the central station 70 adds the identification signal of the call to the authorized list. If the identification signal is already in the authorized list, no action is taken. From block 75, flow proceeds to block 22.

In block 76, the central station 70 adds the identification signal of the call to the unauthorized list. If the identification signal is already in the unauthorized list, no action is taken. If the identification signal is in the authorized list, the identification signal is deleted from the authorized listed and added to the unauthorized list. From block 76, flow proceeds to block 24.

As an option, the keypad of the central station 70 includes a list key, a scroll up key, a scroll down key, and a delete key. During a system programming mode, the list key selects either the authorized list or the unauthorized list to be displayed on the display of the central station 70. Once one of the lists is displayed, the scroll up key scrolls through the displayed list in one direction, and the scroll down key scrolls through the displayed list in the other direction. A displayed identification signal is deleted from the displayed list by pressing the delete key. To delete an identification signal in one of the lists, a combination of the list key, the scroll up key, the scroll down key, and the delete key are used to locate the desired identification signal and delete the desired identification signal from the appropriate list. The delete key, the list key, the scroll up key, and the scroll down key are preferably enabled when a call is not being processed by the central station 70. As with the accept key and the reject key, the other keys of the keypad of the central station 70 have equivalent keys on the telephones 2 and 4.

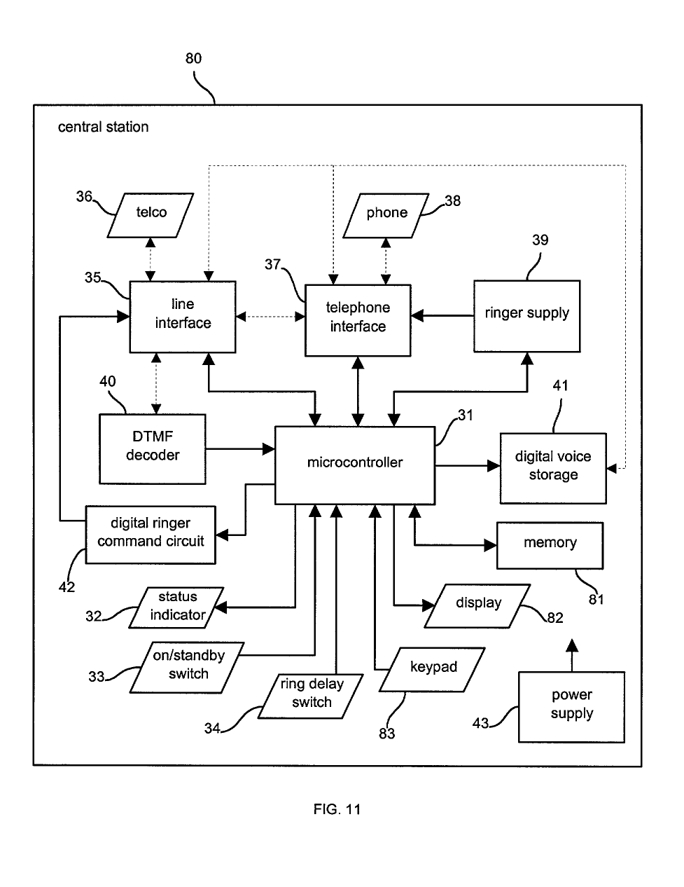

FIG. 11 illustrates a block diagram of an exemplary central station 80. The central station 80 is a preferred example of the central station 70 in FIG. 9. The central station 80 is similar to the central station 30, except for the addition of a memory 81, a display 82, and a keypad 83.

The memory 81 is coupled to the microcontroller 31 and stores the authorized list and the unauthorized list. The memory is preferably a non-volatile EEPROM memory. The memory 81 is preferably segmented into two sections, one for storing the authorized list, and another for storing the unauthorized list. Preferably the two sections are of the same size. More preferably, the section storing the authorized list is able to store 50 identification signals, and the section storing the unauthorized list is able to store 50 identification signals.

As an option for the memory 81, the number of entries for the authorized list and the number of entries for the unauthorized are not pre-set. Instead, the memory 81 is able to store identification signals for a pre-set number of total entries.

As another option for the memory 81, the subscriber can program the central station 70 as to the allocation of the pre-set limit of entries for both the authorized list and the unauthorized list. As an example, the authorized list and unauthorized list are pre-set for 50 entries each. The subscriber can change this allocation to, for example, 20 entries for the authorized list and 80 entries for the unauthorized list.

As a further option for the memory 81, a number of entries in the authorized list and/or unauthorized list are non-rotating entries in the authorized list and/or unauthorized list until specifically changed by the user. These non-rotating entries are not rotated as in a FIFO register. Preferably, the subscriber identifies which entries on which lists are non-rotating entries. This option is useful for a subscriber to include, for example, family members as non-rotating entries on the authorized list, and ex-boyfriends or ex-girlfriends as non-rotating entries on the unauthorized list.

As an option, the memory 81 is integrated with the microcontroller 31.

The display 82 is coupled to the microcontroller 31 and displays identification signals for a call, the authorized list, and the unauthorized list. After the central station 70 determines the identification signal of the call in block 71, the identification signal is displayed using the display 82. The display 82 is also used in a system programming mode. The display 82 is preferably a liquid crystal display (LCD).

The key pad 83 is coupled to the microcontroller 31 and includes keys to access and program the authorized list and the unauthorized list. For example, the key pad 83 includes an accept key, a reject key, a delete key, a list key, a scroll up key, and a scroll down key.

Third Embodiment

The third embodiment is a variation of the first and second embodiments. If a call is passed through by the central station, and if the call is not answered, the call is passed through to a voice mail service of the subscriber. A voice mail service is, for example, a service provided by a provider (e.g., a telephone company) to answer calls for a subscriber to the service and to store and/or forward subscriber-retrievable messages for the subscriber. A voice mail service is generally provided by a system located exterior the residence or business of the subscriber.

For this embodiment, the subscriber subscribes to a voice mail service and a three-way calling service. The two services can be obtained from the same provider or different providers. Examples of such providers include a regional bell operating company or an independent local exchange carrier. This embodiment is useful to a subscriber who does not have an answering machine.

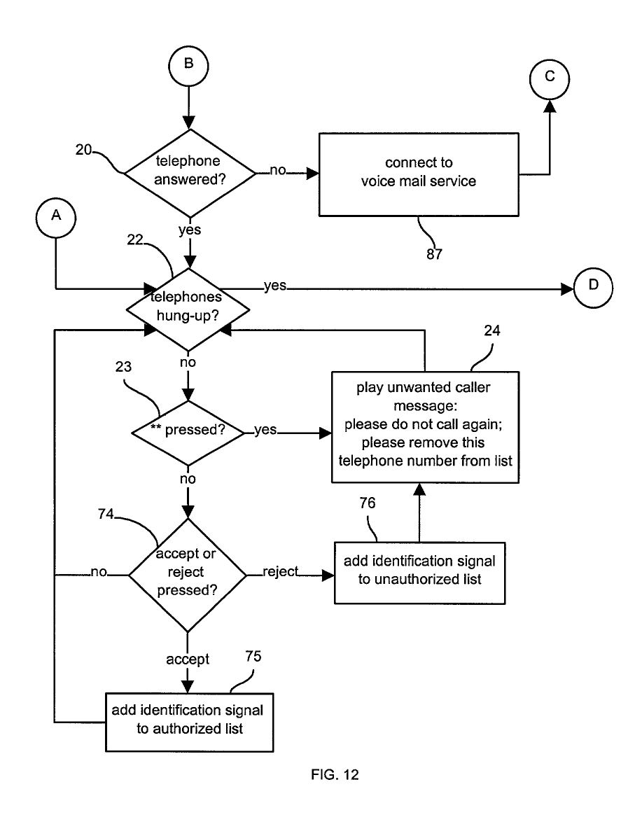

FIG. 12 illustrates a flow diagram for the third embodiment based on the second embodiment. FIG. 12 is the same as FIG. 10B, except block 21 is replaced by block 87. All other blocks in FIG. 12 are the same as those in FIG. 10B. The connectors A, B, C, and D in FIG. 12 connect to the connectors A, B, C, and D in FIG. 10A. If the third embodiment is based on the first embodiment, block 21 in FIG. 2 is replaced by block 87 of FIG. 12, and the following discussion for block 87 is for central station 1 instead of central station 70.

In block 87, the central station 70 connects the call to a voice mail service. The central station 70 initiates a conference call using the three-way caller service. For the conference call, the central station 70 places the call on hold and places a second call to the voice mail service of the subscriber. The central station 70 calls the telephone number of the subscriber, which is stored in the memory of the central station 70, as the second call. The second call receives a busy signal, and the voice mail service answers the call. Once the voice mail service answers the call, the central station 70 connects the call on hold as a three-way conference call with the voice mail service and disengages from the conference call. The call and the voice mail service are thereafter connected, and the voice mail service permits the caller to leave a message in the conventional manner of voice mail services. Once the central station 70 disengages from the three-way conference call, flow proceeds to block 19, where the central station 70 is disconnected from the call.

Fourth Embodiment

The fourth embodiment combines the central station and the digital ringers of the previous embodiments into a single central station. The central station operates in a primary mode or a secondary mode. In the primary mode, the central station operates as the central station 1 or 70 in the previous embodiments. In the secondary mode, the central station operates as a digital ringer 3 in the previous embodiments. A switch on the central station determines which mode the central station operates.

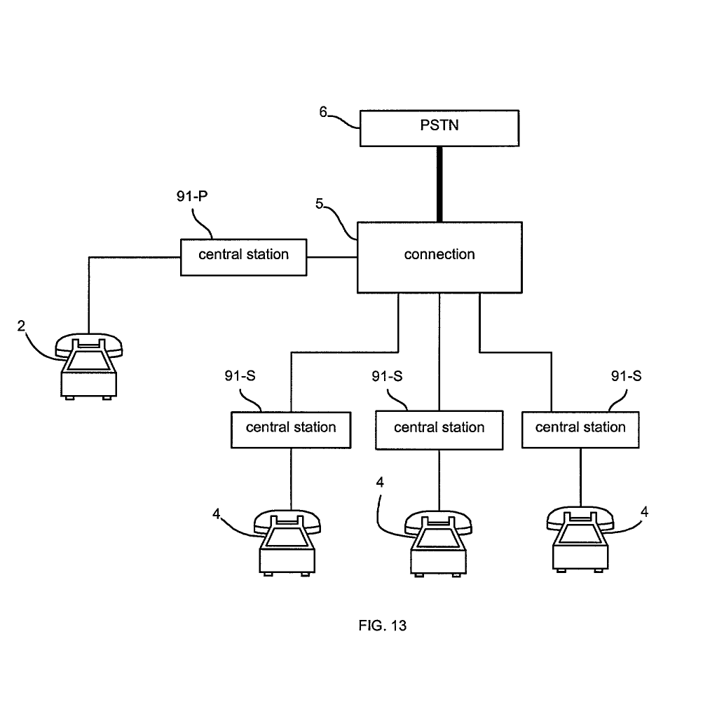

FIG. 13 illustrates a system view for the fourth embodiment. FIG. 13 is the same as FIG. 1, except the central station 1 and the digital ringers 3 are replaced by a central station 91P and central stations 91-S, respectively, which are collectively referred to as central stations 91. Each central station 91 couples a telephone 2 or a telephone 4 to the connection 5. Each central station 91 is capable of being set in the primary mode or the secondary mode. The central station designated 91-P in FIG. 13 is set to operate in the primary mode, and the central station designated 91-S in FIG. 13 is set to operate in the secondary mode.

The mode setting of the central station 91 can be set by the subscriber. As an option, the mode setting cannot be set by to the subscriber. As an option, the mode setting is factory set using, for example, a jumper on a circuit board of the central station 91.

Instead of or addition to central stations 91-S, digital ringers 3 can be used with this embodiment as in previous embodiments.

With this embodiment, an answering machine of the subscriber can be co-located with the telephone 2. In the previous embodiments, an answering machine was preferably only located with the telephone 2.

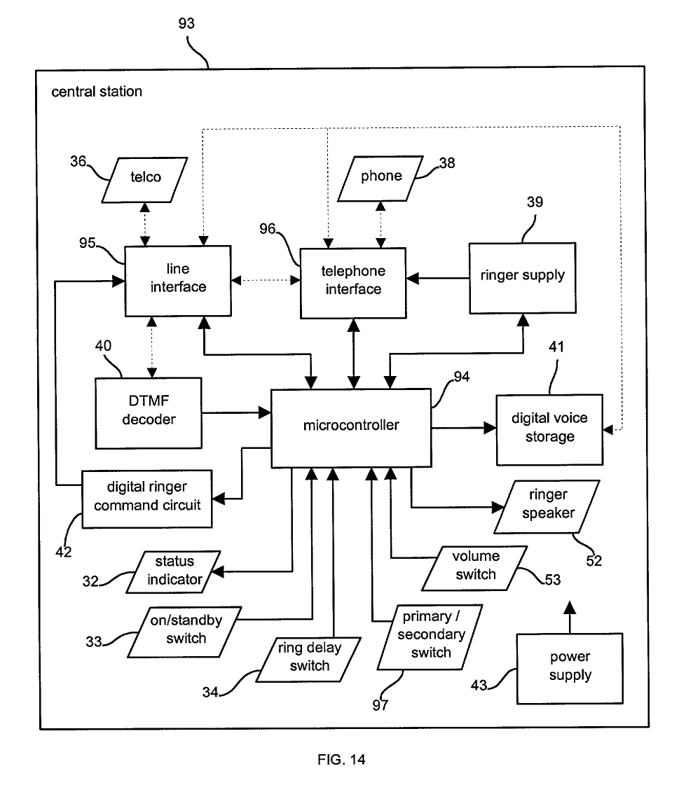

FIG. 14 illustrates a block diagram of an exemplary central station 93. The central station 93 is a preferred example of the central station 91 in FIG. 13. The central station 93 is based on the first embodiment and is a combination of the central station 30 illustrated in FIG. 3 and the digital ringer 50 illustrated in FIG. 6. The central station 93 includes all of the components of the central station 30 and the digital ringer 50, except for the following new elements: a microcontroller 94, a line interface 95, a telephone interface 96, and a primary/secondary switch 97. The microcontroller 94 performs the functions of the microcontroller 31 and the microcontroller 51. The line interface 95 performs the functions of the line interface 35 and the line interface 54. The telephone interface 96 performs the functions of the telephone interface 37 and the ringer silencer 56. The primary/secondary switch 97 is coupled to the microcontroller 94 and sets the central station 93 in the primary mode or the secondary mode. The primary/secondary switch 97 is preferably accessible via a rear panel of the central station 93.

Fifth Embodiment

The fifth embodiment is a modification of the first through fourth embodiments. In the previous embodiments, the central stations and digital ringers were placed between the telephones 2 and 4 and the connection 5, as illustrated in FIGS. 1, 9, and 13. In the fifth embodiment, a central station is placed between the connection 5 and the PSTN 6.

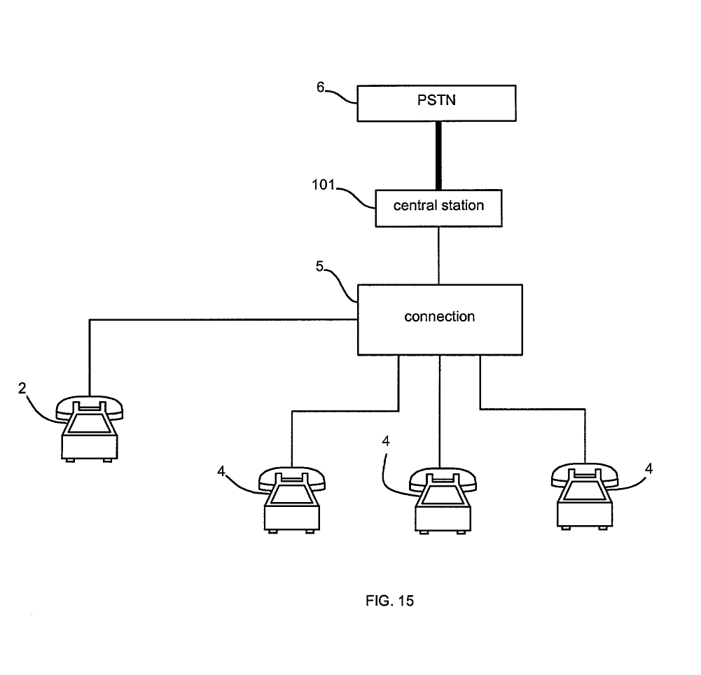

FIG. 15 illustrates a system view for the fifth embodiment. A single central station 101 is placed between the connection 5 and the PSTN 6. No central station 1, 70, or 91-P is needed between the telephone 2 and the connection 5. Further, no digital ringer 3 or central station 91-S is needed between a telephone 4 and the central station 5. The central station 101 is installed at a point where the public telephone line enters the connection 5. If the subscriber is using the central station 101 for a residence, the central station 101 is installed, for example, at the so-called telco block or as part of a residential telecommunication switch. The central station 101 is preferably installed by a professional contractor.

In operation, the central station 101 intercepts a call and prevents the incoming ring voltage of the call passing to the connection 5, which prevents the telephones 2 and 4 from ringing initially. If the call is passed through by the central station 101, the central station 101 generates a ring voltage to cause the telephones 2 and 4 to ring, which is similar to the central station 1 in the first embodiment ringing the telephone 2 if a call is passed through.

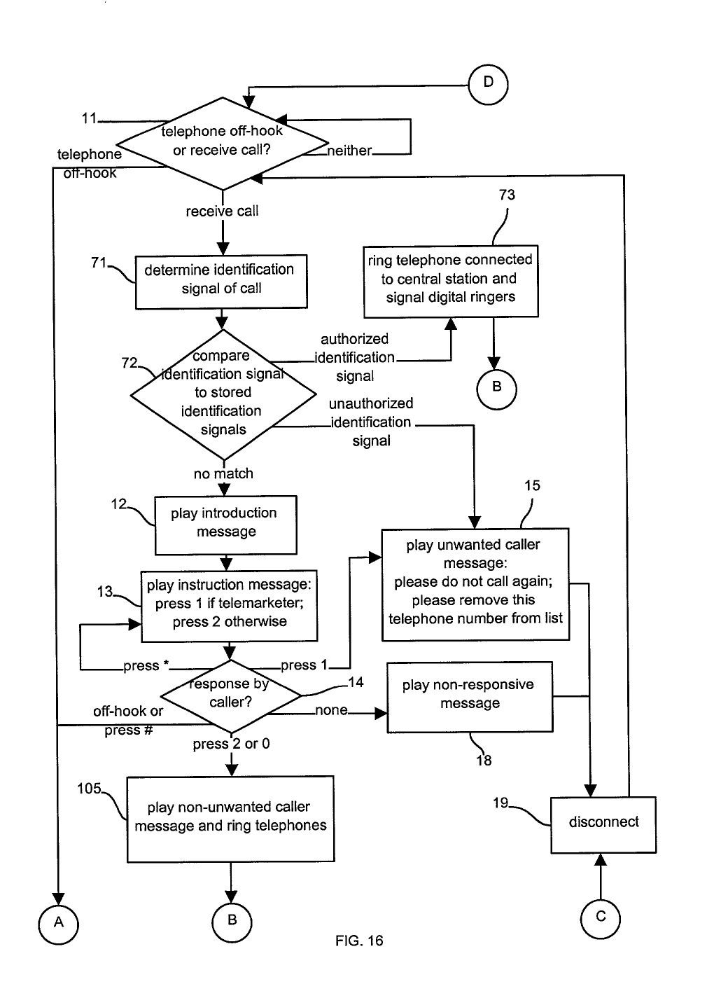

FIG. 16 illustrates a flow diagram of the fifth embodiment. FIG. 5 is identical to FIG. 10A for the second embodiment, except block 16 is replaced by block 105. All other blocks in FIG. 16 are the same as those in FIG. 10A. The connectors A, B, C, and D in FIG. 16 connect to connectors A, B, C, and D in FIG. 10B.

In block 105, the central station 101 plays a non-unwanted caller message and rings the telephones 2 and 4. In comparison to block 16, block 105 likewise plays the non-unwanted caller message, rings not only the telephone 2 but also the telephones 4, but provides no signal to digital ringers.

With the fifth embodiment, space is not required to accommodate the central station and digital ringers next to the telephones 2 and 4 as in the previous embodiments. Further, with the fifth embodiment, digital ringers 3 are not required.

To implement the first and third embodiments with the features of the fifth embodiment, block 16 is replaced by block 105 in the flow diagrams of FIGS. 2 and 12, respectively.

Sixth Embodiment

The sixth embodiment is similar to the fifth embodiment, except the central station is implemented by a company providing telephone service to the subscriber. Examples of such a company include: a local telephone company, such as a regional operating bell company or an independent local exchange carrier; a long distance telephone company; and a telephone company for providing service for a roaming cellular telephone, a roaming digital telephone, or a wireless telephone.

As those skilled in the art will recognize, just as methods and systems of other stand alone systems (e.g., an answering machine) have been implemented by companies providing telephone services to a subscriber, the methods and systems of the invention can likewise be implemented by such companies providing telephone service to a customer. For example, the functionality of the embodiments of the invention can be implemented by a telephone company by modifying the equipment and software used to provide a voice mail service (or answering service), a three-way caller service, a call block service, a caller ID service, and/or a distinctive ring service.

With this embodiment, the central station can blocks calls from telemarketers, even if the subscriber subscribes to a call waiting service. With this embodiment, the telephone company can screen each call prior to passing the call to the subscriber.

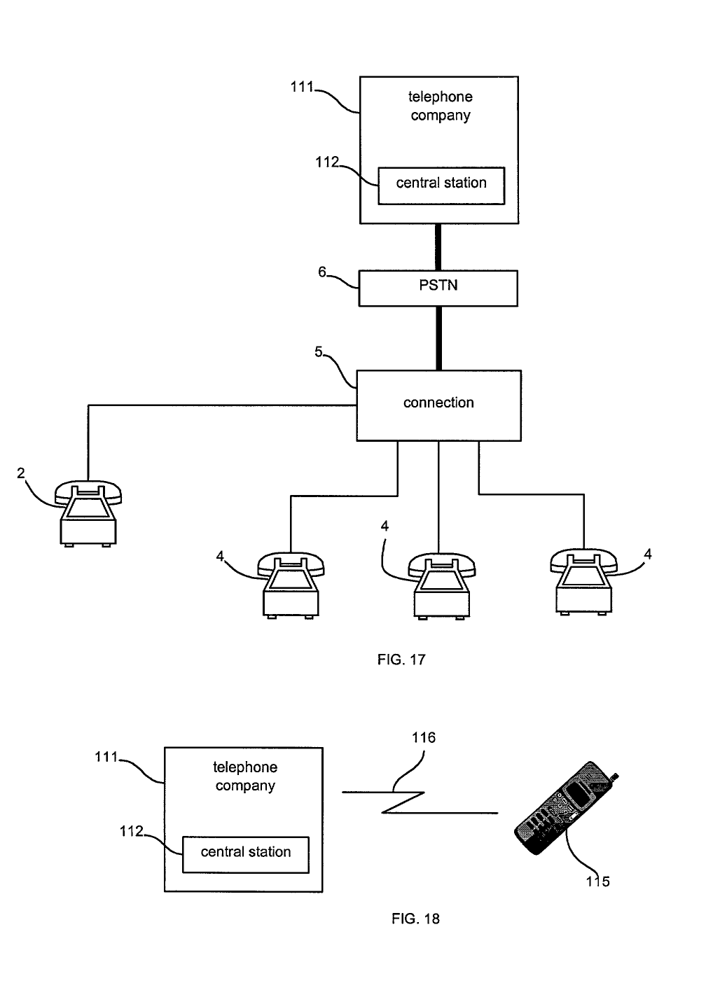

FIG. 17 illustrates a system view for the sixth embodiment. FIG. 17 is similar to FIG. 15, except the central station 101 is located within a telephone company 111 as a central station 112. The telephone company 111 is connected to PSTN 6. The central station 112 implements the functionality of the previous embodiments. Prior to a call being transmitted to the telephones 2 and 4, the central station 112 intercepts the call and determines whether to block the call or pass the call through to the telephones 2 and 4.

FIG. 18 illustrates another system view of the sixth embodiment. FIG. 18 depicts a telephone company 111 communicating via a wireless medium 116 with a telephone 115. The telephone 115 is capable of communicating via the wireless medium 116. The telephone 115 is, for example, a roaming cellular telephone, a roaming digital telephone, a satellite telephone, a wireless telephone, or a laptop computer or personal computer with a wireless modem.

As an option, the telephone company 111 offers an unwanted caller ring-back service in addition to or instead of the central station 112. With the unwanted caller ring-back service, the telephone company provides an unwanted caller ring-back signal to a caller of a telephone number of a subscriber. The unwanted caller ring-back signal is a modified form of the conventional ring-back signal or is in addition to the conventional ring-back signal. The unwanted caller ring-back signal can be provided once or multiple times to the caller. The unwanted caller ring-back signal is detectable by computer systems, such as predictive dialing systems.

In operation, for any calls to the telephone number of the subscriber, the telephone company 111 provides the unwanted caller ring-back signal to the caller of the telephone number of the subscriber. If a predictive dialing system, or a similar type of system, is the caller, the predictive dialing system detects the unwanted caller ring-back signal, disconnects the call, and updates automatically a list to refrain from further calling the telephone number. The predictive dialing system updates automatically a list, for example, by placing a name corresponding to the telephone number and/or the telephone number on a do-not-call list or by removing a name corresponding to the telephone number and/or the telephone number from a to-call list

As a further option, the telephone company 111 provides the unwanted caller ring-back signal to the caller prior to providing the ring voltage to the telephone of the subscriber. The telephone company 111 introduces a delay period in the telephone call with this further option. If the caller disconnects the call (e.g., a predictive dialing system detected the unwanted caller ring-back signal) prior to the end of the delay period, no ring voltage is provided to the telephone of the subscriber.

Seventh Embodiment

The seventh embodiment embeds the central station and/or digital ringer of the previous embodiments in the telephone of the subscriber. With this embodiment, a separate central station and/or digital ringer is not needed. Digital ringers 3 and telephones 4 can be used with this embodiment as in previous embodiments.

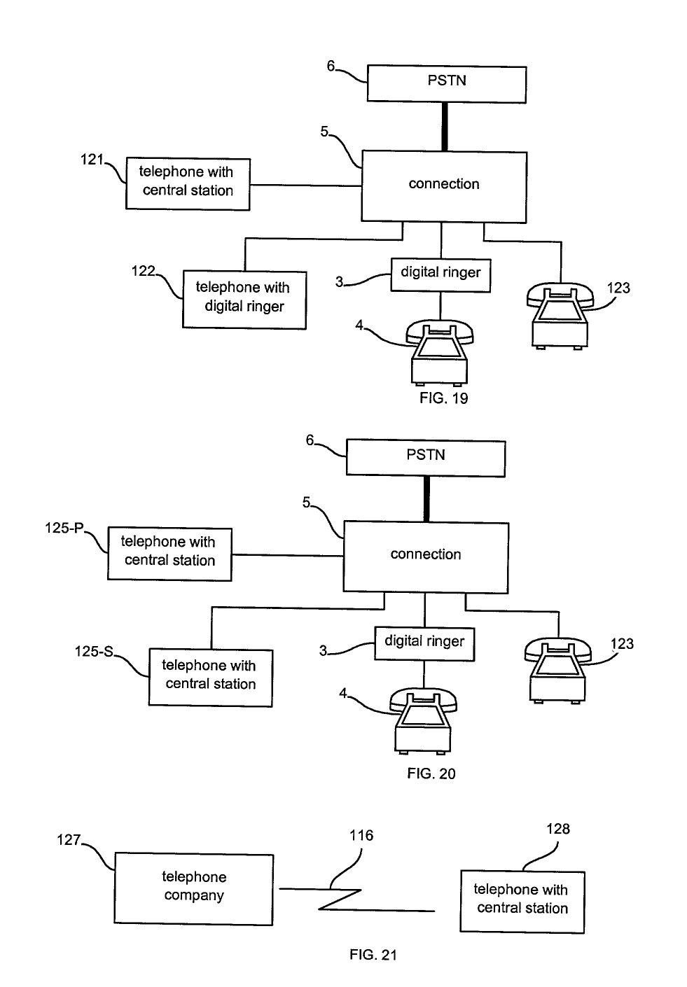

FIG. 19 illustrates a system view for a seventh embodiment of the invention. FIG. 19 is similar to FIG. 1, except the central station 1 and the telephone 2 is replaced by a telephone 121 with central station, and the digital ringer 3 and the telephone 4 is replaced by a telephone 122 with digital ringer. The telephone 121 integrates the features of a telephone and a central station of the previous embodiments. The telephone 122 integrates the features of a telephone and a digital ringer of the previous embodiments. A telephone 123 is conventional and operates in the conventional manner. The digital ringer 3 and the telephone 4 operate as in previous embodiments.

FIG. 20 illustrates another system view for the seventh embodiment. FIG. 20 depicts the embedding the features of the fourth embodiment in a telephone. FIG. 20 is the same as FIG. 19, except the telephone 121 and the telephone 122 are replaced by a telephone 125-P with central station and a telephone 125-S with central station, respectively, which are collectively referred to as telephones 125. Each telephone 125 integrates the features of a telephone and the central station of the fourth embodiment. Each telephone 125 is capable of being set in the primary mode or the secondary mode. The central station designated 125-P in FIG. 20 is set to operate in the primary mode, and the central station designated 125-S in FIG. 20 is set to operate in the secondary mode. The telephone 123 is conventional and operates in the conventional manner. The digital ringer 3 and the telephone 4 operate as in previous embodiments.

FIG. 21 illustrates a further system view for the seventh embodiment. FIG. 20 depicts a telephone company 127 communicating via a wireless medium 116 with a telephone 128 with central station. The telephone 128 is capable of communicating via the wireless medium 116 and integrates the features of a telephone and a central station of the previous embodiments. The telephone 128 is, for example, a roaming cellular telephone, a roaming digital telephone, a satellite telephone, a wireless telephone, or a laptop computer or personal computer with a wireless modem, which includes a central station of the previous embodiments.

In various embodiments, several DTMF touch-tone activated features are described as being activated by, for example, the # key, the * key, **, *1, and *2. Any alternative DTMF touch-tone key combination can be used to activate the various features of the invention. Further, instead of activating the various features of the invention with DTMF touch-tones, the various features of the invention can be activated using the voice of the caller and/or subscriber along with voice and/or speech detection techniques.

In general, the invention can be implemented along any point in the signal path and for any medium through which an unwanted caller can convey a call to a customer. The signal path includes, for example, the point at which the signal is generated up to and including the point at which the signal is received by the customer. Examples of conveying a call include generating, sending, and transmitting a call. Examples of the medium include cable, wire, fiber optic, cellular, digital, satellite, and a network, such as the Internet.

In general, the invention can be implemented with a variety of systems, for example: stand alone systems; telephone and/or telephony equipment (e.g., answering machines, Caller ID devices, telephone sets, and the like) and telephone and/or telephony services (e.g., call waiting, call forwarding, voice mail, paging, signal transmission, and the like) implementing the method and/or system of the invention or providing the method and/or system of the invention; and telephone signal providers (e.g., local and/or regional firms (e.g., Verizon and the like), long distance providers (e.g., AT&T, MCI, 10-10-1234, and the like), Internet service providers, and the like) implementing the method and/or system of the invention or providing the method and/or system of the invention.

The embodiments of the invention have been described with respect to one example of an unwanted caller, namely a telemarketer. The embodiments of the invention, however, are not restricted to telemarketers and can be used to block calls from other unwanted callers.

All of the examples described herein are non-limiting examples.

The invention has been described in detail with respect to preferred embodiments, and it will now be apparent from the foregoing to those skilled in the art that changes and modifications may be made without departing from the invention in its broader aspects, and the invention is intended to cover all such changes and modifications as fall within the true spirit of the invention.

What is claimed is:

1. A method for blocking calls for a subscriber comprising the steps of:
receiving a call from a caller;
providing a first audio message to said caller requesting said caller to provide a first indicator if said caller is an unwanted caller or a second indicator otherwise, wherein knowledge of said first indicator and/or said second indicator is not required by said caller;
receiving said first indicator or said second indicator;
blocking said call if said first indicator is received; and
passing through said call if said second indicator is received.

2. A method as in claim 1, further comprising the step of suppressing at least one telephone of said subscriber from ringing after receiving said call.

3. A method as in claim 1, wherein said first and second indicators are dual tone multi-frequency signals.

4. A method as in claim 1, wherein said first indicator and/or second indicator are received if spoken by said caller.

5. A method as in claim 1, wherein said audio message further requests said caller to provide said second indicator for a first recipient and at least one additional indictor for an additional recipient.

6. A method as in claim 1, further comprising the step of providing an introduction message prior to providing said audio message.

7. A method as in claim 6, wherein said introduction message is a second audio message, a tone, or a note series.

8. A method as in claim 1, wherein said step of receiving comprises receiving said first indicator, said second indicator, or a third indicator;
wherein said method further comprises the step of disconnecting said call if said third indicator is received.

9. A method as in claim 1, wherein said step of blocking said call comprises the steps of:
providing a second audio message to said caller requesting that said caller refrains from again calling said subscriber; and
disconnecting said call.

10. A method as in claim 9, wherein said second audio message requests that said caller add a name corresponding to said telephone number to a do-not-call list and/or requests that said caller add said telephone number to a do-not-call list.

11. A method as in claim 9, wherein said second audio message requests that said caller remove a name corresponding to said telephone number from a to-call list and/or requests that said caller remove said telephone number from a to-call list.

12. A method as in claim 1, wherein said step of passing through said call comprises the step of ringing at least one telephone of said subscriber.

13. A method as in claim 1, wherein said step of passing through said call comprises the steps of:
ringing a primary telephone of said subscriber; and
providing a signal to indicate a ringing at least one secondary telephone of said subscriber.

14. A method as in claim 13, wherein said signal is provided via a telephone line coupling said primary telephone and said at least one secondary telephone or via a wireless communication link.

15. A method as in claim 13, wherein said signal rings a device coupled to said at least one secondary telephone.

16. A method as in claim 13, wherein said signal commands a device coupled to said at least one secondary telephone to ring said at least one secondary telephone.

17. A method as in claim 1, wherein said step of passing through said call comprises the steps of:
waiting to receive a fourth indicator; and
blocking said call if said fourth indicator is received.

18. A method as in claim 1, further comprising the steps of:
maintaining an unauthorized list and an authorized list;
receiving an identification signal for said call;
comparing said identification signal with said unauthorized list and said authorized list;
blocking said call if said identification signal is included in said unauthorized list; and
passing through said call if said identification signal is included in said authorized list.

19. A method as in claim 18, wherein said step of passing through said call further comprises the steps of:
receiving an unauthorized indicator or an authorized indicator from said subscriber;
including said identification signal in said unauthorized list and disconnecting said call if said unauthorized indicator is received; and
including said identification signal in said authorized list if said authorized indicator is received.

20. A method as in claim 19, wherein said unauthorized and authorized indicators are DTMF tones.

21. A method as in claim 1, wherein said step of passing through said call comprises the steps of:
waiting for said subscriber to answer said call within a time period;
forwarding said call to an answering service if said subscriber fails to answer said call within said time period.

22. A method as in claim 21, wherein said answering service is provided by a telephone service provider.

23. A method as in claim 1, wherein said step of passing through said call comprises the steps of:
placing said call on hold using a three-way calling service of a telephone service provider; and
placing a second call using said three-way calling service of said telephone service provider.

24. A method as in claim 1, further comprising the step of operating in a primary mode or a secondary mode;
wherein said primary mode comprises said steps of providing, receiving, blocking, and passing, and further comprises the step of transmitting a ring activation signal if said second indicator is received; and
wherein said secondary mode comprises the step of producing a ringing signal upon receipt of said ring activation signal.

25. A method as in claim 1, wherein said step of passing through said call comprises passing through said call to a connection for a public switch telephone network.

26. A method as in claim 1, wherein said step of passing through said call comprises passing through said call to a public switch telephone network.

27. A method as in claim 1, wherein said step of passing through said call comprises passing through said call to a wireless medium.

28. An apparatus for blocking calls for a subscriber comprising:
means for receiving a call from a caller;
means for providing a first audio message to said caller requesting said caller to provide a first indicator if said caller is an unwanted caller or a second indicator otherwise, wherein knowledge of said first indicator and/or said second indicator is not required by said caller;
means for receiving said first indicator or said second indicator;
means for blocking said call if said first indicator is received; and
means for passing through said call if said second indicator is received.

29. An apparatus as in claim 28, wherein said apparatus further comprises means for coupling said apparatus between a telephone line and a telephone of said subscriber.

30. An apparatus as in claim 28, wherein said apparatus is integrated in a telephone of said subscriber.

31. An apparatus as in claim 28, further comprising:
means for maintaining an unauthorized list and an authorized list;
means for receiving an identification signal for said call;
means for comparing said identification signal with said unauthorized list and said authorized list;
means for blocking said call if said identification signal is included in said unauthorized list; and
means for passing through said call if said identification signal is included in said authorized list.

32. An apparatus as in claim 28, wherein said apparatus further comprises means for passing said call to an answering service if said call is unanswered.

33. An apparatus as in claim 28, wherein said apparatus further comprises means for switching said apparatus between a primary mode and a secondary mode.

34. An apparatus as in claim 28, wherein said apparatus further comprises means for coupling said apparatus between a public switch telephone network and a connection to said public switch telephone network.

35. An apparatus as in claim 28, wherein said apparatus further comprises means for integrating said apparatus with a residential telecommunications switch.

36. An apparatus as in claim 28, wherein said apparatus further comprises means for integrating said apparatus with telecommunications equipment of a telephone service provider.

37. A kit comprising:
a central station to couple a telephone and a telephone line and to prevent said telephone from ringing if an unwanted caller calls said telephone.

38. A kit as in claim 37, further comprising a digital ringer to couple a secondary telephone and said telephone line, to suppress ringing of said secondary telephone, and to produce a ringing sound when prompted by said central station.

39. A kit as in claim 37, wherein said digital ringer is prompted by said central station via said telephone line.

40. A kit as in claim 37, wherein said central station comprises means for switching said central station between a primary answering mode and a secondary answering mode.

41. A kit as in claim 37, wherein said central station is integrated with said telephone.

42. A kit comprising:
a digital ringer to couple a telephone and a telephone line, to suppress ringing of said telephone, and to produce a ringing sound when prompted by an activation code received via said telephone line.

43. A kit as in claim 42, wherein said digital ringer is integrated with said telephone.

44. A method for blocking calls for a subscriber comprising the steps of:
receiving a call from a caller at a telephone number, said caller dialing said telephone number automatically; and
providing an introduction message, wherein said introduction message is an electronic telephonic signal detectable by said caller such that said caller automatically disconnects said call and updates automatically a list to refrain from further calling said telephone number again.

45. A method as claim 44, wherein said caller places a name corresponding to said telephone number and/or said telephone number on a do-not-call list.

46. A method as claim 44, wherein said caller removes a name corresponding to said telephone number and/or said telephone number from a to-call list.

47. A method as claim 44, wherein said introduction message is an audio message, a tone, or a note series.

48. A method as claim 47, wherein said tone is a non-service interruption tone.

49. An apparatus for performing the method of claim 44.

50. A method for automatically dialing telephone numbers comprising the steps of:
dialing a telephone number automatically to initiate a call;
detecting an introduction message;
disconnecting said call automatically; and
updating automatically a list to refrain from further calling said telephone number again.

51. An apparatus for performing the method of claim 50.
